(19) United States
(12) Patent Application Publication
(10) Pub. No.: US 2013/0204674 A1
(43) Pub. Date: Aug. 8, 2013

(54) Method and System For Performing Appraisals

(71) Applicant: Arun Nathani, Pune (IN)

(72) Inventor: Arun Nathani, Pune (IN)

(21) Appl. No.: 13/598,578

(22) Filed: Aug. 29, 2012

(30) Foreign Application Priority Data
Feb. 7, 2012 (IN) 352/MUM/2012

(51) Int. Cl. G06Q 10/06

(52) U.S. Cl. 705/7.42

(57) ABSTRACT

The embodiments herein relate to employee management system and more particularly, to employee management in appraisal system. The embodiments herein disclose an appraisal system using a modified form of Activity Hierarchy Process (AHP). The appraisal system covers all the facets of appraisal to measure individual's “Capabilities” is disclosed. Every employee in an organization will be included in the appraisal system and the capabilities of the employees are measured to determine a value based on the rank given to the employees.

This application claims priority from Indian application 352/MUM/2012 titled “A METHOD AND SYSTEM FOR PERFORMING APPRAISALS” and filed on 7 Feb. 2012.

### TECHNICAL FIELD

The embodiments herein relate to human resource management systems and more particularly, to a method of assessment in a human resource management system.

### BACKGROUND

Employees in an organization play a vital role in creating value to the organization. Employees should be motivated to attain best results and the motivation may be in the form of the appraisal system that occurs once or twice in a year.

Analytic Hierarchy Process (AHP) is a method for capturing knowledge, experience and intuition and is frequently used in appraisal processes. AHP comprises a series of method to form a hierarchy by arranging all the elements that comprises of facing decision making problem, making a paired comparison in one-to-one hierarchy and making element for the resultant comparison, weighting the element, attaining a resultant weight of the alternatives of decision making. AHP has been used to assist numerous corporate and government decision makers, such as choosing project, formulating drug policy, choosing product marketing strategy and others.

AHP is a multi-criteria decision making process which provides comprehensive, logical and structured framework. It improves understanding of complex decisions by decomposing the problem. The application of the AHP has been extended to the appraisal system that determines the capability value of each individual which can be effectively used in decision making such as resource management, trainers list, interviewer list, and so on.

The existing use of AHP in appraisal system has some complexities pertinent to the calculation of Transitivity error, priority scale and comparison scale. Transitivity is the relation between three elements such that if a relation is true between the first and second element and is also true between the second and third element, then it must necessarily be true between the first and third element. If this relation is false then the three elements have a transitivity error. Existing system considers transitivity error at the end of the process of comparison by introducing a parameter called confidence scale to ranking based on the extent of transitivity errors found. The introduction of the confidence scale at the end of the process makes the calculation of transitivity error cumbersome. Existing AHP suggests the range of priority to be from −9 to +9. This range of scale will not make the decision consistent across organization, comprehendible and simplified to use. Also, the existing AHP uses numeric value of comparison of scale size of −9 to +9; this increases the scope of the subjectivity (bias). Also, current appraisal systems using AHP do not consider calculating the value of the employee and the system lacks the employee ranking based on some parameters like technical knowledge, IQ and so on. Also, the existing system did not address biasness that occurs while ranking the employees.

### SUMMARY

In view of the foregoing, an embodiment herein provides a method for ranking employees of an organization using a computerized system, the method comprising generating a group of employees from the organization by the system; selecting parameters from among a set of pre-defined parameters by an identified group head for the group; performing parameter comparison for employees for the generated group based on the parameters selected by the system; performing transitivity error check by the system; calculating ranks for employees of the group based on the parameter comparison by the system; and determining value of employees of the group by the system based on the calculated ranks.

Also, disclosed herein is a system for ranking employees of an organization, the system comprising at least one means configured for generating a group of employees from the organization; receiving a selection of parameters from among a set of pre-defined parameters by an identified group head for the group; performing parameter comparison for employees for the generated group based on the parameters selected; performing transitivity error check; calculating ranks for employees of the group based on the parameter comparison; and determining value of employees of the group based on the calculated ranks.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a basic block diagram of the network, according to the embodiments of the present application;

FIG. 2 illustrates a block diagram of an appraisal system, according to an embodiment of the present application;

FIG. 3 is a block diagram that illustrates different modules used in the appraisal system, according to the present application;

FIG. 4 is a flow diagram illustrating a process involved in the appraisal system of the present application;

FIG. 5 is a flow diagram illustrating a process involved in value determination, according to the present application;

FIG. 6 is a flow diagram illustrating an example process involved in calculating the people disparity in the appraisal system, according to the present application;

FIG. 7 is a table illustrating the list of information stored in database, according to the present application;

FIG. 8 is a table structure illustrating the group details in the appraisal system, according to the present application;

FIG. 9 is a table structure illustrating the details of the group member in the appraisal system, according to the present application; and

FIG. 10 is a table structure illustrating the employee points, according to the present application.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

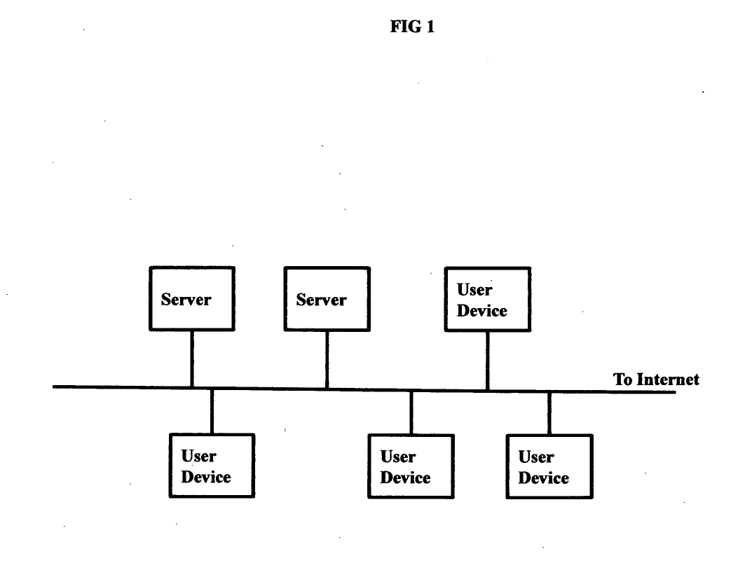

The embodiments herein disclose an appraisal system using a modified form of Analytic Hierarchy Process (AHP). Referring now to the drawings, and more particularly to FIGS. 1 through 10, where similar reference characters denote corresponding features consistently throughout the figures, there are shown embodiments.

Appraisal system covers all the facets of appraisal to measure individual's “Capabilities” is disclosed. Every employee in an organization will be included in the appraisal system and the capabilities of the employees are measured to determine a value based on the rank given to the employees.

FIG. 1 illustrates the basic block diagram of the network, according to the embodiments of the present application. FIG. 1 depicts a plurality of user device and servers present on a network. The network may be any suitable network type such as a Local Area Network (LAN), Wide Area Network (WAN) and so on. The network may also use any suitable network architecture. The user devices may connect to the server using the network. The user devices may also connect to the internet and external networks using the network connection.

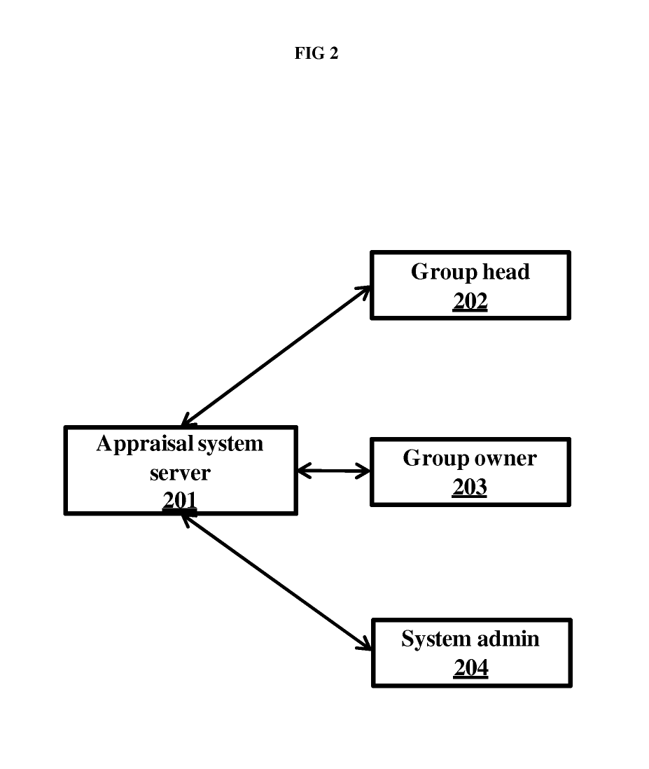

FIG. 2 illustrates the general block diagram of the appraisal system according to embodiments as disclosed herein. The general block diagram comprises the appraisal system server 201 that is connected with the group head 202, group owner 203 and system admin 204. The group head 202, group owner 203 and system admin 204 are connected with the appraisal system server 201 by any of the means such as wired, wireless and so on. In one embodiment the wired communication may be LAN (Local Area Network) or any other wired network and the wireless communication may include WLAN (Wireless Local Area Network), Wi-Fi, GPRS, LTE and the like.

In one embodiment, the aforementioned group head 202 may be a senior manager or any higher official who can supervise the manager of a group. And group owner 203 may be a manager, a supervisor or any other higher officials who can rank the employees in a group. The group head 202, group owner 203, system admin 204 has a communication device to communicate with one another and with the appraisal system server 201.

The embodiments herein refer to the communication device used by the group head 202, group owner 203 and system admin 204 is personal computer (PC) however; the scope may not be limited to the same and may be extended to any other communication device like laptop, mobile phone, PDA, tablet and the like.

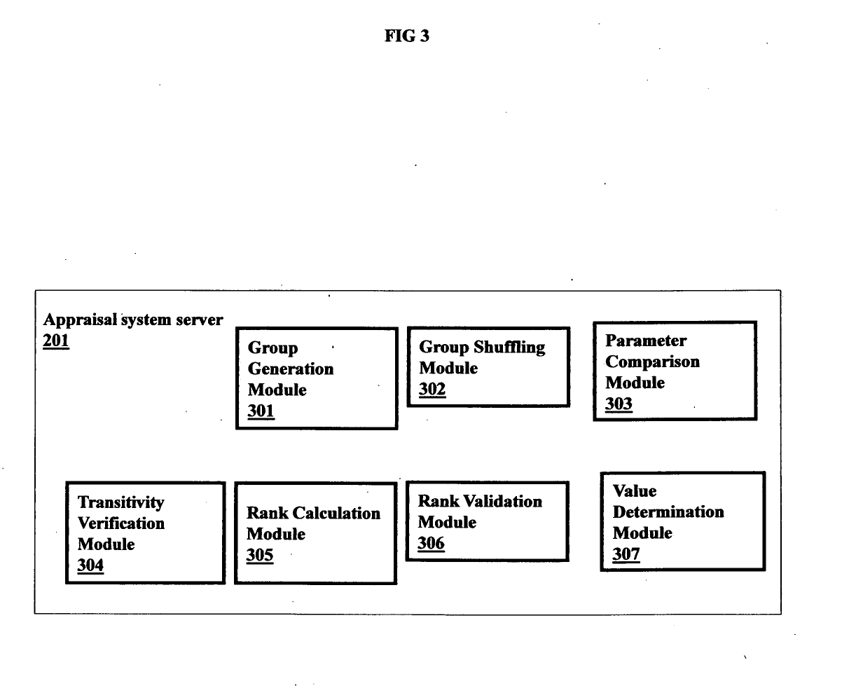

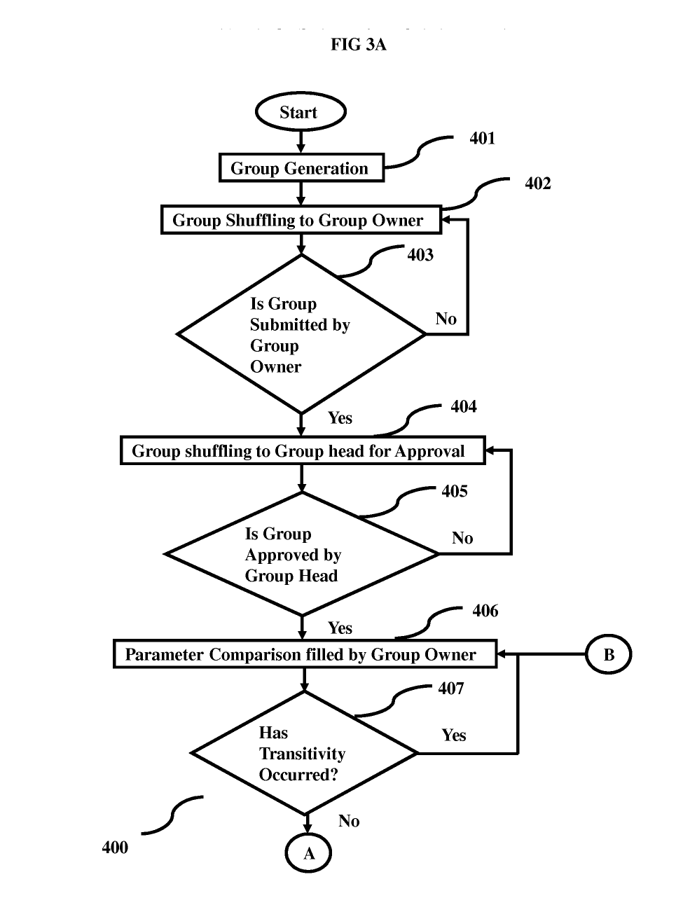

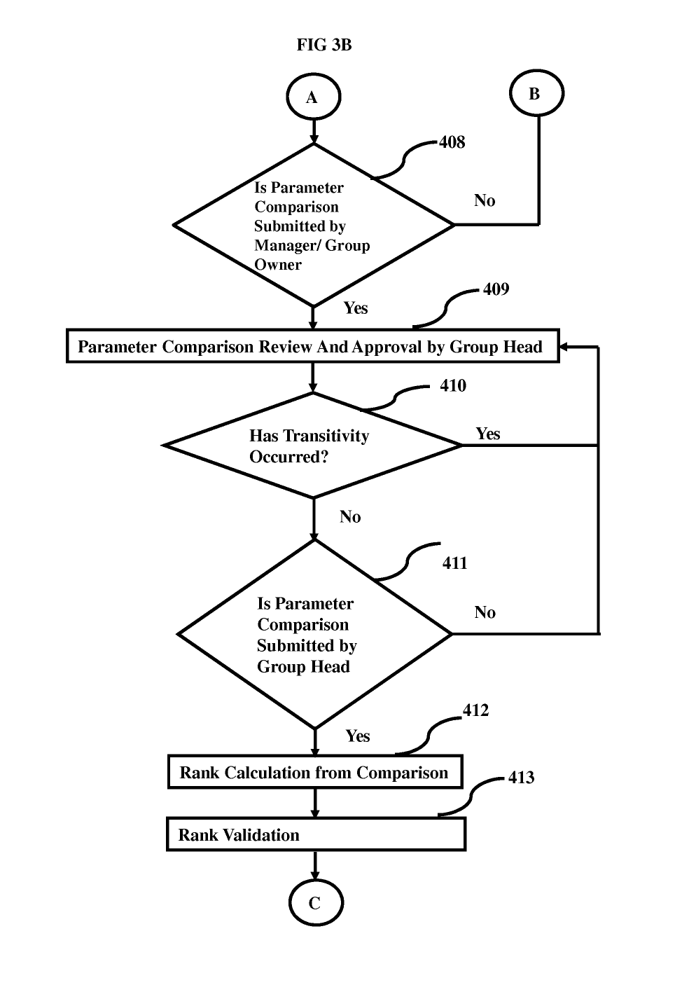

FIG. 3 is a block diagram that comprises different modules associated with the appraisal system server 201 according to the embodiments of the present application. The modules includes group generation module 301 that generates the group of employees and maintain the number of employees in a group to be between 8 and 15. In one embodiment the group size can be of any range, and not restricted to 8-15. The group shuffling module 302 checks whether the group is shuffled with the employees of another group. It ensures that the employees in the group are from similar departments whose capability attributes are similar, like engineers, testers, managers and so on. The parameters are identified on the basis of which the employees are ranked. The parameters may be identified by a group comprising of at least one of Human Resources personnel, department leads and any other related personnel. The parameters may be reviewed and/or revised at periodic intervals. The parameters comparison module 303 may assist in comparing the parameters identified by the manager to rank the employees. Parameters may be specific to each department in the organization. In one embodiment the parameters specific to engineering department includes technical knowledge, intelligence quotient, processes, sincerity & reliability, communication skills, interpersonal skills and so on. In one embodiment, parameters specific to the management department includes project management, process knowledge & implementation, sincerity, reliability & organization support, relationship management, people management, communication, technical skills, leadership, and intelligence quotient and so on. In one embodiment, parameters specific to the quality department may be sincerity, reliability & attitude, technical knowledge, communication, interpersonal skills, processes, intelligence quotient, and automation/white-box testing and so on.

The transitivity verification module 304 checks for the transitivity error that occurs in the ranks assigned by manager of a group. The transitivity of the system defines the relation between three elements such that if a relation is true between the first and second element and is also true between the second and third element, then it must necessarily be true between the first and third element. If this relation is false then the three elements have a transitivity error.

Rank calculation module 305 provides relative ranks of all employees in a group on each parameter created by the group owner 203 after the transitivity error has been checked by the transitivity verification module 304.

Rank validation module 306 validates the ranks on different aspects to ensure consistency, removal of biasness and so on. Value determination module determines 307 the value based on ranking output from frontend.

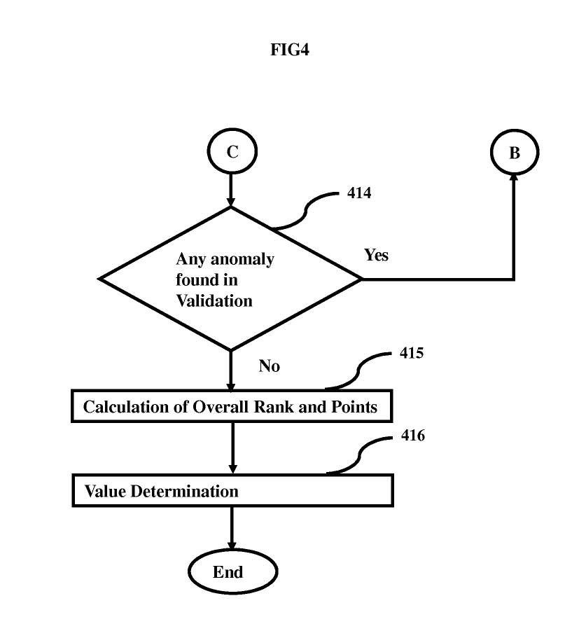

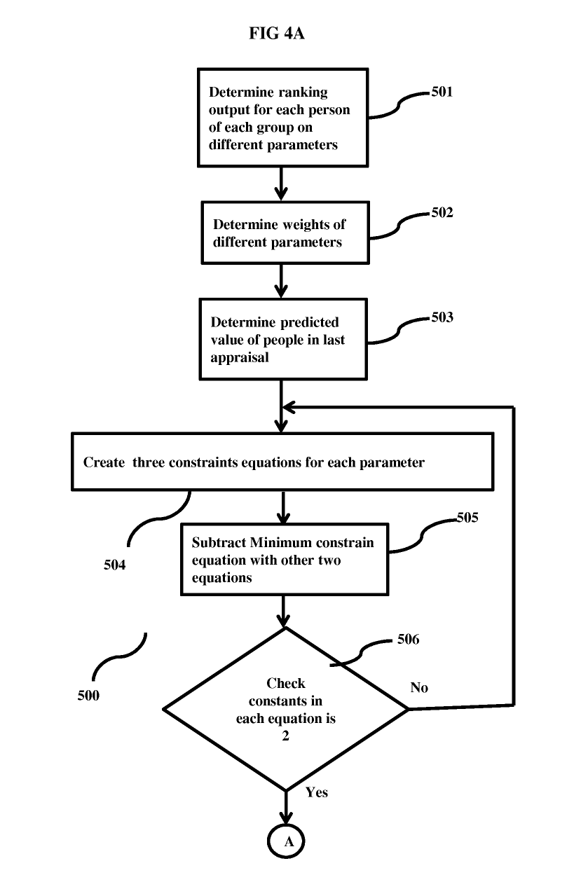

FIG. 4 is a flow diagram (400) that describes the working of the appraisal system, according to the present application. Server 201 generates (401) a group with employees on the basis of department, designation, and project combination. In one embodiment, the groups are generated based on department and separate groups on department basis, in such a way that all the employees in a particular department are put together in a single group. In another embodiment, server 201 generates the groups based on department and designation wise to create separate groups on the basis of department and designation combination. All the employees for a particular department and designation are put together in a single group. The groups are formed in such a way that the group owner 203 knows the capabilities of the employee in the group and can provide accurate judgment. It also helps the group owner 203 to appraise team members with similar skill sets. In one embodiment a group size of eight to fifteen accurately represents heterogeneity in terms of capability distribution of employees as present in the whole organization.

In one embodiment, group shuffling is done (402) when the total number of members in a group is less than eight. The server 201 checks (403) whether the group is submitted by the group owner 203 and send (404) the group for shuffling to the he group head 202 for approval. The server 201 checks the group size is less than eight (minimum size) then the group goes to the group head 202 for shuffling and group head approves (404) the group. When group head 202 approves the group (405), the group owner 203 ranks the group. The server 201 then checks (405) whether the group is approved by the group head 202. If the group is approved by the group head 202 then it takes the group for parameter comparison filled by the group owner 203. If the server 201 finds that the group is not approved by the group head 202, then the server again takes the group for shuffling to the group head 202 for approval.

The parameters may vary with departments which may include different human attributes, such as IQ, technical knowledge, hardworking and so on. The transitivity module in the server 201 checks (407) whether any transitivity occurred within the parameters generated by the group owner 203. If no transitivity occurred between the parameters, then group owner 203 sends (408) the parameter comparison to the group head 202 for approval. Group head 202 will look at the parameters comparison and sends (409) the approval to the group owner 203. The server 201 checks (410) for transitivity error in the parameter at the time of comparison. In one embodiment, the parameter comparison may be submitted (411) by the group head 202 to the server.

Once the group head 202 approves the parameter comparison, the group owner 203 or a manager ranks the employees in the group based on the comparisons between the employees in a group. In one embodiment, group owner 203 uses simple operators such as >, =, <(>means 3, =means 2 and <means 1) to compare and rank the members of each group and carries a certain weightage.

The server 201 finds (412) out the relative rank of all employees in a group on each parameter. Then the server 201 associates a cumulative rank to the employees in a group based on the comparisons. In one embodiment, server 201 ranks each employee both on individual parameters such as communication, technical knowledge and so on, as well as finds out cumulative rank comprising of all parameters. Server 201 uses a weightage factor provided by the manager on each parameter to find out the cumulative rank. In one embodiment, server 201 may rank an employee as 4 for communication parameter and the weightage factor provided by the manager for this communication parameter is 3, then the server finds the cumulative rank to the employee as 12 (the product of the rank of the employee and the weightage factor provided by the manager).

Further, the server 201 validates (413) the rank of group members by comparing them on different aspects to ensure consistency, removal of biasness and so on. In one embodiment, server 201 has different check-points for rank validation. In rank validation, the server 201 show details of group having same rank count in more than one parameters and its average rank count for appraisal and decision problem.

In one embodiment, the server 201 checks for the same group biasedness. If a group consists of almost same level of people (for example, a group comprising of up to 80% fresher), then there should of variance in ranking. Lack of variance in the ranking indicates biasedness in the group. In another embodiment, the server 201 compares based on designation by showing the comparison of parameter points of employee across different group of given decision problem for that respective appraisal. In another embodiment, server 201 checks the variance in the rank by comparing the ranking of related parameters like technical skill, IQ and so on. Server 201 understands that someone with good IQ can be technically good or vice versa. Server 201 checks if anyone ranked high on one and low on another parameter can be caught as inconsistent. Server can also check the rank validation by different means and not restricted to the methods mentioned above.

Server 201 checks (414) for any anomalies in the rank validation and calculate (415) the overall rank and points for individual parameter. In one embodiment, server 201 determines (416) the value of the rank and the predicted value of the employee based on this value.

FIG. 5 is a flow diagram illustrating a Server 201 executes (500) value determination algorithm to find the value of the rank assigned to the employee in a group. Predicted value is based on ranking output from front end and needs a graph/equation type. In one embodiment, graph/equation type may be linear, exponential, log, antilog, parabolic and so on. To execute the algorithm the server needs some inputs such as ranking output for each person of each group on different parameters (501), weights of different parameters (502) and predicted salaries of people in last appraisal (503). In one embodiment, the server calculates the new predicted value of the person by the following equation:

New Predicted value of a person=Equation_of_graph (ranking output of front end for a person).

The server 201 iterates through each group and executes the following steps on each one of them. It determines the predicted value of the group by creating (404) three constrain equations to get the maximum, minimum and total of predicted value of the group as follows:
1. Max Predicted value for a group=Equation_of_graph (theoretical maximum predicted value from the group itself with some deviation cap)
2. Min Predicted value for a group=Equation_of_graph (theoretical minimum predicted value from the group itself with some deviation cap)
3. Total of predicted value for a group=Equation_of graph (real total of ranking output of front end for a group).
   Server 201 finds the maximum, minimum and total of predicted value based on the theoretical rank output from the frontend for a group. It then subtracts (505) the minimum predicted value for a group with the other two equations. In one embodiment, server 201 checks (506) whether number of constants in each equation are 2. It then solves (507) the equations and finds the value of the constants and then substitutes (508) the value of the constants against each ranking output from front end to find the predicted value on each parameter. Server 201 finally calculates (509) the predicted value of the employee from the weighted average of predicted salaries on each parameter of the employee.

In one embodiment, server 201 calculates the people disparity in the appraisal system. People Disparity indicates value of a group versus cost and how well a manager gauges people while ranking them for appraisal. This disparity takes into consideration that the deviation between what people make and what they deserve, which implies the deviation between the actual value and the predicted value or the value proposition.

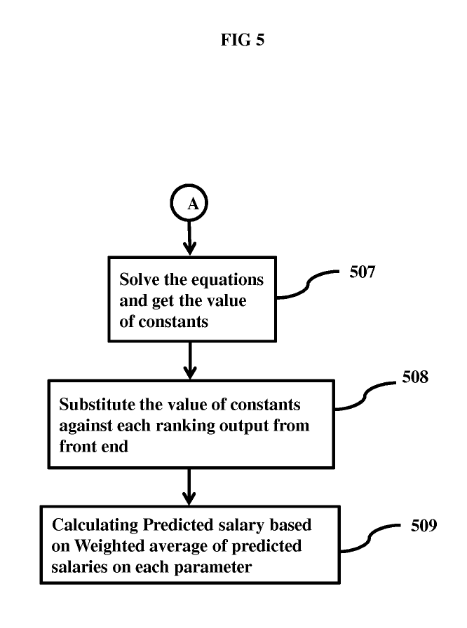

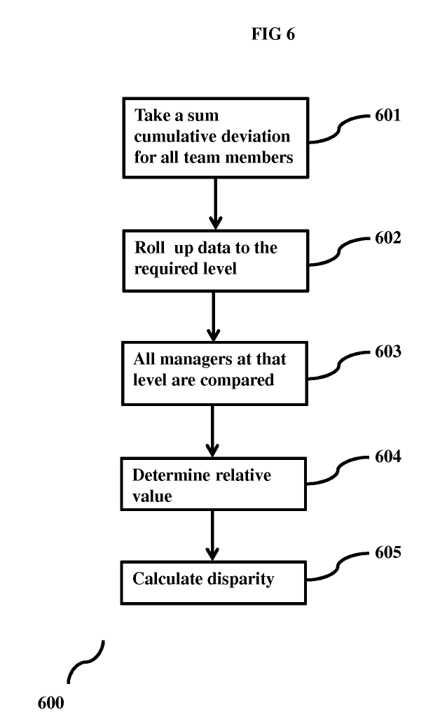

FIG. 6 is a flow diagram illustrating (600) a process involved in calculating the people disparity in the appraisal system, according to the present application. The server 201 determines (601) the sum of the cumulative deviation for all team members. And then it rolls up (602) this data to the required level. Then it compares (603) all the managers at that level to determine (604) relative value and calculate (605) disparity. In one embodiment, server 201 calculates the people disparity or value loss of particular customer or project or department by taking the average of value loss considering all resources coming under particular customer or project or department or their combinations and the like. Based on the aforementioned details server 201 calculates the value loss of each resource as follows:

Value Loss=Absolute of ((1−Value of the particular resource)/Value of the top member in the group)).

In one embodiment, server 201 calculates the value of top member by considering all resources under a particular customer or project or department or their combination and the like. In one embodiment, the average loss is shown on User Interface (UI) as people disparity of individual customer or department manager or project manager or project or department or their combinations and the like.

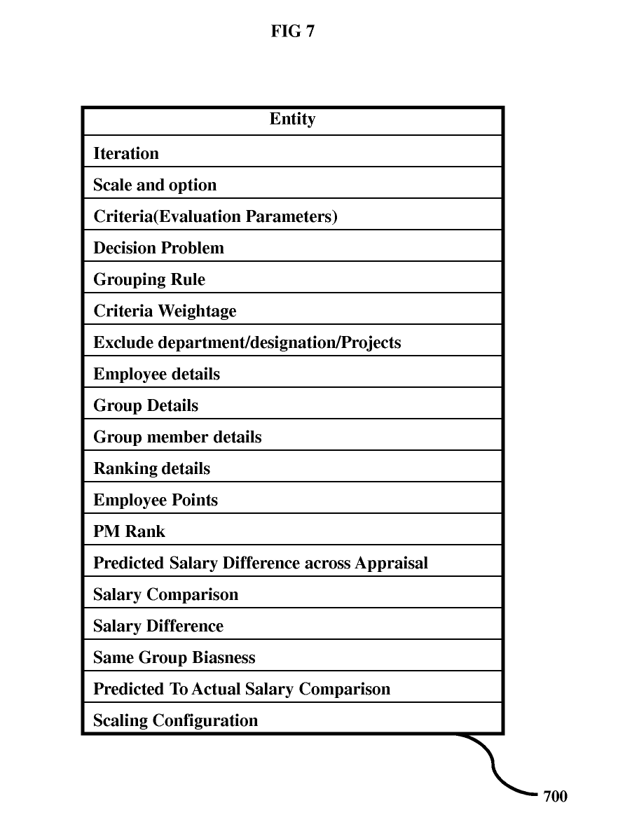

FIG. 7 is a table illustrating (700) the list of information stored in database, according to the present application. In one embodiment, server 201 stores information of different entities in the database which includes the iteration that refers to the appraisal month and year for which appraisal is configured, scale and option refers to the comparison operator used for ranking by the server. A criterion (Evaluation Parameters) refers to the parameters used for employee comparison. Decision Problem is decided based on department, designation and designation level. Grouping Rule refers to the mapping of decision problem and decision problem level according to department and designation. Criteria Weightage refers to the each evaluation parameter weightage for comparison. Apart from the aforementioned entities server also stores information on employee details, group details, group member details, ranking details, employee points and the like.

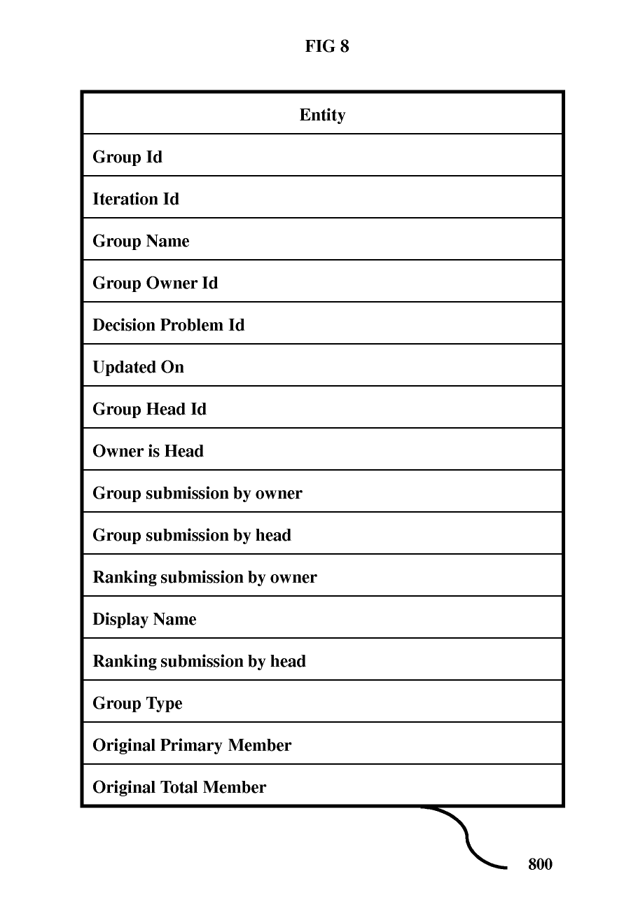

FIG. 8 is a table structure illustrating (800) the group details in the appraisal system, according to the present application. In one embodiment, server 201 stores information on different entities about the group in the database which includes but not limited to group Id, iteration Id, group name, group owner Id, decision problem Id, updated On, group head Id and the like.

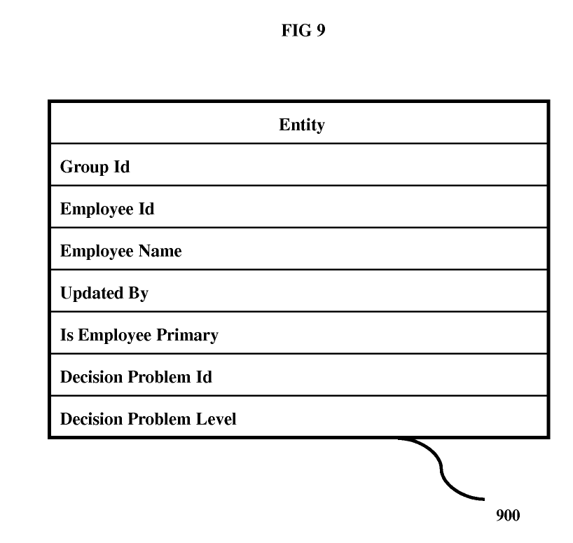

FIG. 9 is a table structure illustrating (900) the details of the group member in the appraisal system, according to the present application. Server 201 stores the details of the group member in the database. In one embodiment, server 201 stores the information on different entities related to the group members which includes and not limited to group Id that refers to the unique system generated Id of the group, Employee Id refer to the employee id of member in the group, Employee Name refer to the name of employee in the group, Updated by refer to the person who updated the employee id. Is Employee Primary checks whether the employee is primary or secondary employee, decision problem Id refer to the unique id that is decided based on department, designation and designation level and decision problem level refer to the level that is decided based on department, designation and designation level.

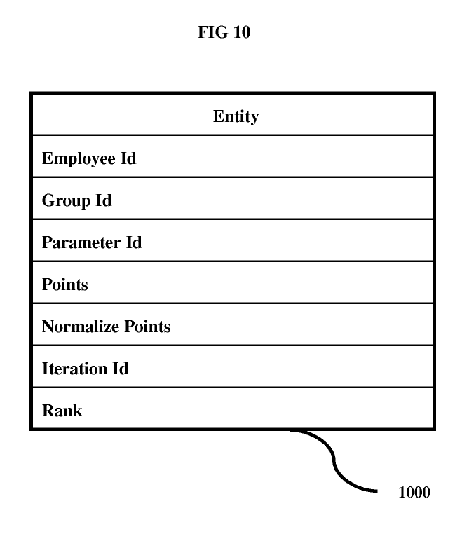

FIG. 10 is a table structure illustrating (1000) the employee points, according to the present application. Different employee points are used by the server 201 which includes but not limited to employee Id that refers to the employee id of member in that group, Group Id refers to the foreign key for group table, Parameter Id refers to the foreign key assigned to individual parameter, Points refers to the individual parameter's points, normalize Points refers to the normalizing individual parameter's points, Iteration Id refers to the appraisal month and year for which appraisal is configured and rank refers to the employee's rank for particular parameter based on points.

Embodiments disclosed herein consider the transitivity error during the process of comparison, hereby making the process of end calculation cleaner and simpler.

The embodiments disclosed herein can be implemented through at least one software program running on at least one hardware device and performing network management functions to control the network elements. The network elements shown in FIGS. 1, 2 and 3 include blocks which can be at least one of a hardware device, or a combination of hardware device and software module.

The embodiment disclosed herein specifies a server for appraisal system. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

I claim:

1. A method for ranking employees of an organization using a computerized system, said method comprising:
generating a group of employees from said organization by said system;
selecting parameters from among a set of pre-defined parameters by an identified group head for said group;
performing parameter comparison for employees for said generated group based on said parameters selected by said system;
performing transitivity error check by said system;
calculating ranks for employees of said group based on said parameter comparison by said system; and
determining value of employees of said group by said system based on said calculated ranks.

2. The method, as claimed in claim 1, wherein said group of employees are generated by said system based on at least one of
designation of employees in said group;
department of employees in said group; or
skill set of employees in said group.

3. The method, as claimed in claim 1, wherein a minimum size and a maximum size is specified for each of said group.

4. The method, as claimed in claim 1, wherein said method further comprises of performing validation of said calculated ranks by said system.

5. The method, as claimed in claim 1, wherein said method further comprises of
predicting bias for employees of said group by said system; and
adjusting value determined for employees of said group by said system, on detecting bias.

6. The method, as claimed in claim 5, wherein said predicting bias for employees of said group comprises of
checking pattern of ranking of said group by said system across similar parameters;
checking pattern of ranking of employees of said group by said system across parameters;
checking pattern of ranking of employees of said group by said system with recent movement history; and
grouping rated parameters by said system.

7. The method, as claimed in claim 1, wherein ranks are from a scale of 1 to 9.

8. A system for ranking employees of an organization, said system comprising at least one means configured for:
generating a group of employees from said organization;
receiving a selection of parameters from among a set of pre-defined parameters by an identified group head for said group;
performing parameter comparison for employees for said generated group based on said parameters selected;
performing transitivity error check;
calculating ranks for employees of said group based on said parameter comparison; and
determining value of employees of said group based on said calculated ranks.

9. The system, as claimed in claim 8, wherein said system is configured for generating said group of employees based on at least one of
designation of employees in said group;
department of employees in said group; or
skill set of employees in said group.

10. The system, as claimed in claim 8, wherein said system is further configured for specifying a minimum size and a maximum size for each of said group.

11. The system, as claimed in claim 8, wherein said system is further configured for performing validation of said calculated ranks.

12. The system, as claimed in claim 8, wherein said system is further configured for
predicting bias for employees of said group; and
adjusting value determined for employees of said group on detecting bias.

13. The system, as claimed in claim 12, wherein said system is configured for performing predicting bias by
checking pattern of ranking of said group across similar parameters;
checking pattern of ranking of employees of said group across parameters;
checking pattern of ranking of employees of said group with recent movement history; and
grouping rated parameters.

14. The system, as claimed in claim 8, wherein said system is configured for assigning ranks on a scale of 1 to 9.
